(19) United States
(12) Patent Application Publication
(10) Pub. No.: US 2018/0134387 A1
(43) Pub. Date: May 17, 2018

(54) Aerial Device Capable of Additive Manufacturing and Associated Method

(71) Applicant: Imperial Innovations Limited, London (GB)

(72) Inventors: Mirko Kovac, London (GB); Edward McFarlane, London (GB)

(21) Appl. No.: 15/578,648

(22) PCT Filed: May 18, 2016
(86) PCT No.: PCT/GB2016/051427

§ 371 Date: Nov. 30, 2017

(30) Foreign Application Priority Data
Jun. 1, 2015 (GB) 1509510.2

(51) Int. Cl. B64D 1/18; B64C 39/02; B64D 47/08; G01C 21/16; B33Y 30/00; B33Y 50/02; B29C 64/20; B29C 64/393; G06T 7/70; G06K 9/00

(52) U.S. Cl. CPC B64D 1/18; B64C 39/024; B64D 47/08; G01C 21/16; B33Y 30/00; B33Y 50/02; B64C 2201/126; B29C 64/393; G06T 7/70; G06K 9/0063; B64C 2201/024; B64C 2201/108; B64C 2201/127; B29C 64/20

(57) ABSTRACT

An aerial device (100) capable of controlled flight comprises a first body (110) comprising a lift generator for providing lift to the aerial device (100); a second body (208) comprising a substance dispenser (122) for controllably dispensing a curable substance for additive manufacture; an articulated coupling assembly (200) coupling the first body (110) to the second body (208); an actuator (212; 214; 216) operable to articulate the articulated coupling assembly (200) so as to move the second body (208), and thereby the substance dispenser (122), relative to the first body (110); and a controller operable to control the lift generator, the substance dispenser (122), and the actuator (212; 214; 216).

### FIELD

This disclosure relates to an aerial device capable of controlled flight, and in particular, but without limitation, to an aerial device comprising a manipulable substance dispenser for additive manufacturing.

### BACKGROUND

Robots are often used in the construction and architecture industries for fabrication purposes. Since the 1980s, mobile robots have been used to carry out assembly and construction tasks such as welding, painting, bricklaying and decommissioning. However, traditional ground construction robots such as gantry and industrial robots are often constrained by predefined working areas that hinder their scale of action, and that limit the size and scope of pieces of work they may act upon.

The use of flying robots for carrying out construction tasks is a solution that overcomes some of the main limitations of predefined working areas faced by ground robots. Some of the benefits that flying robots bring over traditional ground robots include:
the ability to operate dynamically in space, especially in areas difficult to access, such as those at high altitude;
the ability to work in co-operation with other flying robots to accelerate the construction process;
the ability to more precisely lay out and assemble materials for construction;
the ability to eliminate dangers for human workers, especially those involved in roof work or other high-altitude work, and the ability to safely navigate dangerous terrains.

### SUMMARY

Aspects and features of the invention are set out in the appended claims.

### BRIEF DESCRIPTION OF THE DRAWINGS

Examples of the present disclosure will now be explained with reference to the accompanying drawings in which:

FIG. 1 shows a quadcopter;

FIG. 2 shows a delta robot;

FIG. 3 shows a block diagram of a system for implementing elements of the approach described herein;

FIG. 4 is a sketch of aerial devices in various circumstances;

FIG. 5 shows a model of a delta arm;

FIG. 6 shows a build area map;

FIG. 7 shows a delta arm prototype;

FIG. 8 shows a charger prototype;

FIGS. 9 and 10 show CAD models of a delta arm;

FIG. 11 shows position Z m data for head motion with dynamic simulation of motor torque 0.1 Nm and payload mass of 40 g;

FIG. 12 shows velocity Z ms⁻¹ data for head motion with dynamic simulation of motor torque 0.1 Nm and payload mass of 40 g;

FIG. 13 shows a vertical male type charger port; and

FIG. 14 shows a model of a delta arm.

Throughout the description and the drawings, like reference numerals refer to like parts.

### DETAILED DESCRIPTION

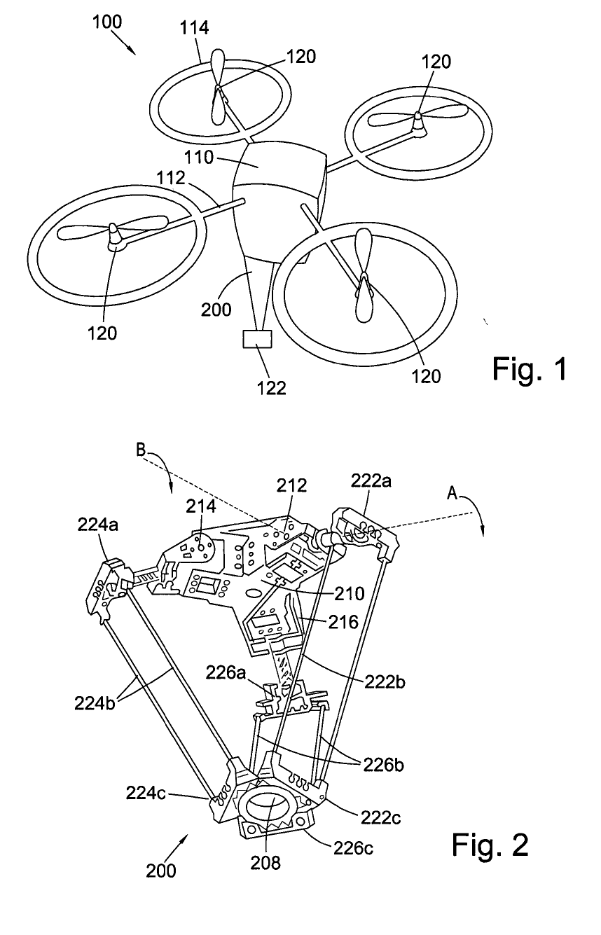

An example of an aerial device is shown in FIG. 1. The aerial device 100 comprises a number of rotors, which may for example be propellers, and which render the aerial device 100 capable of controlled flight. The aerial device 100 of FIG. 1 has four propellers 120, and is accordingly referred to as a ‘quadcopter’. The propellers 120 are mounted to a first body 110 of the aerial device 100, and are arranged to rotate relative thereto. When rotated, the propellers 120 provide lift to the aerial device 100, allowing it to fly. In the example of FIG. 1, the body 110 includes arms 112 and rings 114.

The aerial device 100 further comprises a substance dispenser 122 operable to controllably dispense a curable substance for additive manufacture (i.e. for ‘3D printing’). In order to move the substance dispenser 122 relative to the first body 110 of the aerial device 100, the aerial device 100 comprises an articulated coupling assembly 200, which couples the first body 110 of the aerial device 100 to a second body of the aerial device 100 to which the substance dispenser 122 is coupled.

The articulated coupling assembly may form part of a so-called ‘delta robot’ or ‘delta arm’, as illustrated in FIG. 2.

The delta robot 200 comprises two platforms: a base 210 and a second body (or head) 208. The base 210 of the delta robot 200 is fixedly mounted to the first body 110 of the aerial device 100, for example, to its underside. As another possibility, the base of the delta robot 200 may be integral with the first body 110 of the aerial device 100. The head 208 of the delta robot 200 is coupled to an end-effector—in this case the substance dispenser 122. As another possibility, the head of the delta robot 200 may be integral with the substance dispenser 122. The delta robot 200 enables the substance dispenser to be controllably moved in relation to a target site for dispensing the curable substance.

To this end, the delta robot 200 comprises three arms 222, 224, 226 coupling the base 210 to the head 208. Each arm 222, 224, 226 comprises a respective upper portion 222a, 224a, 226a a respective intermediate portion 222b, 224b, 236b and a respective lower portion 222c, 224c, 226c. Each intermediate portion comprises two parallel sub-arms, that are each coupled to the head 208 and the base 210 via respective ball and socket joint. Actuators 212, 214, 216 control the movement of arms 222, 224, 226 and at least a portion of each actuator 212, 214, 216 is mounted to the base 210 of the delta robot 210. The actuators 212, 214, 216 allow the upper portions 222a, 224a, 226a of the arms to rotate about two axes, thereby allowing the head 208 to rotate with two degrees of freedom. As an example, actuator 212 is operable to cause rotation of upper portion 222 about axes A and B of FIG. 2.

Like most aerial devices, quadcopters suffer from small instabilities and drift in position, and maintaining a fixed reference point to the ground is challenging as disturbing forces, such as wind and ground effects, cannot be absorbed through a physical medium and instead must be compensated for through thrust vectoring. However, the inventors have appreciated that, as state of the art flight controllers can only achieve a hover accuracy of about 7 cm while hovering close to the ground, their accuracy is not sufficient for 3D printing. The delta robot 200 is operable to decouple the movement of the base 210 and the head 208, thereby allowing the head 208 to maintain a constant position in spite of changes in the position of the base 210.

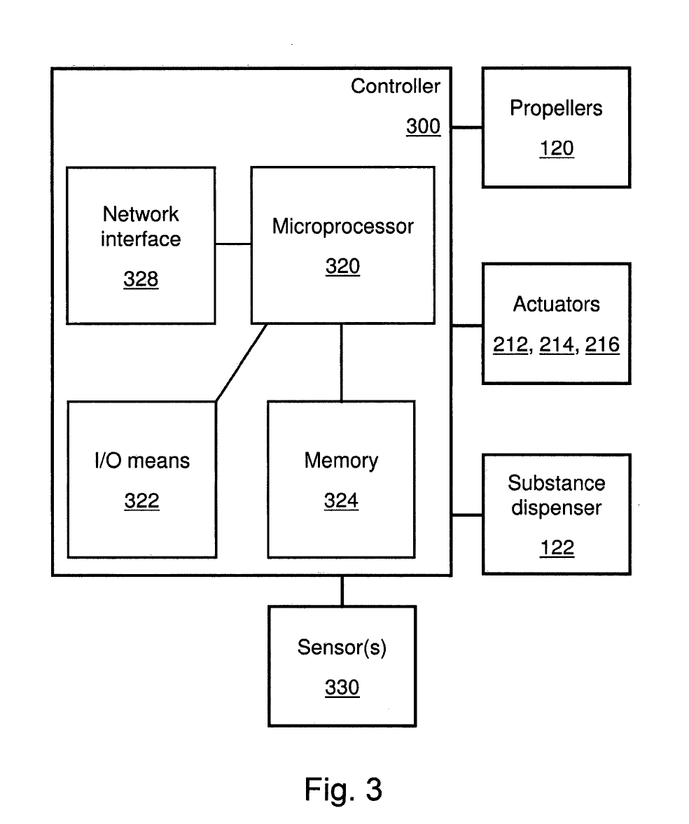

FIG. 3 shows a block diagram of a system for operating the aerial device 100 as described herein. In particular, a controller 300 comprises a microprocessor 320 arranged to execute computer-readable instructions as may be provided to the controller 300 via input/output means 322 which may be arranged, without limitation, to interface with one or more wired or wireless ports, for example a USB port. The microprocessor 320 may also store instructions in a memory 324, for example a random access memory. The microprocessor 320 is arranged to output results of executed programmes at the input/output means 322, and/or may communicate those results to another device via a network interface 328 that is arranged to couple, preferably in a wireless manner, the controller 300 to a communications network such as the internet (not shown in FIG. 3). The microprocessor 320 may be further arranged to receive instructions and/or data via the network interface 328. In particular, the microprocessor 320 may receive commands from a base station which remotely controls the flight of the aerial device 100. The microprocessor may also be arranged to receive sensor data from one or more sensors 330, such as a camera or accelerometer.

As a result of executing the computer-readable instructions, the microprocessor 720 may be arranged to control the propellers 120 in order to fly the aerial device 100. In particular, the microprocessor 720 may control the angle of propellers 120 relative to the horizontal and/or the amount of lift provided by individual propellers 120. In addition, the microprocessor 720 may be arranged to control the substance dispenser 122, and/or to control the actuators 212, 214, 216 in order to move the head 208 of the delta robot 200 and thereby move the substance dispenser 122.

There are a number of ways in which the controller 300 can control the actuators 212, 214, 216 in order to move the head 208. For example, the controller may receive position-related information, and control the actuators 212, 214, 216 based on this information; for example, using the algorithm described in Section 3.2 below.

The position-related information may comprise image information from one or more cameras (which may form part of a motion capture or optic flow system), such as a Vicon, an Xbox Kinect®, Virtual Reality (VR) headset, and/or approaches such as those used in Project Tango, Steam Lighthouse, and Oculus Position Tracking. These cameras may be on-board the aerial device 100. Alternatively, the cameras may be on or near the surface on which the curable substance is to be dispensed, in which case the image information from these cameras could be received via the network interface 328.

The image information may enable the controller 300 to determine how far the substance dispenser 122 is from a target site, and to control the actuators 212, 214, 216 to move the substance dispenser 122 back towards the target site. This determination may be aided by placing markers (such as reflective markers) on the target site. Alternatively, cameras on or near the target site may determine the position of the substance dispenser 122 or aerial device, and may send a command to the controller 300 instructing it to change the position of the substance dispenser 122.

The position-related information may be supplemented by information provided by one or more inertial measurements units—for example from an accelerometer forming part of the aerial device 100.

As will be described in more detail below, the substance dispenser 122 is used to store, mix and dispense two or more chemicals that when combined produce an adhesive or other curable substance such as a foam.

The substance dispenser 122 comprises an actuator portion and a mixing portion. The actuator portion and mixing portion are each coupled to a pair of containers or reservoirs. Each reservoir contains a chemical stored therein.

The actuator portion comprises a lead screw driven by a motor. The lead screw is linked to plunger that is used to force the chemicals out of two reservoirs. The reservoirs are placed parallel and in-line with the lead screw. The power required for the motor is matched to the force required to move the plunger.

The mixing portion includes a Y-splitter fluidly linking the reservoirs to a mixing nozzle. The mixing nozzle is joined to a reaction chamber and a printing nozzle.

When activated by the motor, the lead screw causes the plunger to translate and force the two chemicals out of the reservoirs. The two chemicals are mixed by joining their respective flows with the Y-splitter and pumping them through a disposable mixing nozzle. The mixing nozzle is a static mixer, whose internal geometry enhances mixing of the two chemicals. At the exit of the mixing nozzle, the two chemicals are substantially fully mixed.

In order to increase the amount of time during which the two chemicals react, the two chemicals flow to the reaction chamber following their mixing in the mixing nozzle. In a preferred example, the mixture is of an adequate viscosity for deposition approximately 90 seconds after the flow initiates.

When foam or the desired adhesive begins to form in the reaction chamber, air is pressurised in the reaction chamber so that the material is pushed to the printing nozzle. The substance dispenser 122 includes a valve to prevent outflow of the chemical mixture prior to complete mixing and reaction.

A method of using the substance dispenser 122 will now be described. Under control of controller 300, the propellers 120 are activated and used to provide lift to the aerial device 100. The controller 300 further controls a camera module to collect image data of the surrounding environment. For example, using on-board cameras, the camera module is able to construct a map of the surrounding environment. Using techniques known in the art, the controller 300 may process the image data in order to controllably navigate or otherwise fly the aerial device 100 within the surrounding environment.

A target site in the surrounding environment is then identified. For example, the target site may be identified by a user transmitting the location of the target site to the aerial device 100. Alternatively, the target site may be identified by the controller 300 processing the image data generated by the camera module. The target site may be identified by a suitable computer vision software algorithm, for example by using SLAM (Simultaneous Localization and Mapping) or OpenCV (Open Source Computer Vision). Such software algorithms are able to create a 3D map of the surrounding environment based on the image data generated by the camera module.

Once the target site is identified, controller 300 controls propellers 120 so as to controllably fly the aerial device 100 towards the target site. In the present example, the aerial device 100 may fly or hover directly above the target site in order to be in a position to dispense the adhesive onto the target site. In other examples, however, it is envisaged that the aerial device 100 may be arranged to dispense the adhesive through other apertures; for example, the aerial device 100 may be arranged to dispense the adhesive laterally with respect to the aerial device 100, instead of vertically downwards. In particular, the aerial device 100 may land adjacent the target site prior to applying the adhesive.

When in position above the target site, the controller 300 controls substance dispenser 122, and communicates with controlling circuitry to activate the actuator portion of the substance dispenser 300 and activate the plunger so as to begin the chemical mixing process. In some examples, the chemicals may be mixed before the aerial device 100 reaches the target site, such that the adhesive is ready for dispensing by the time the aerial device 100 has reached the target site. Once the controller 300 determines that the chemicals are mixed (for example once a predetermined amount of time has elapsed from the initiation of the mixing process), the valve of substance dispenser 122 is opened so as to allow the adhesive to be dispensed ejected via the printing nozzle.

In some examples, the aerial device 100 may be arranged to pick up objects and affix them to target sites using an adhesive delivered from substance dispenser 122. For example, it is envisaged that the aerial device 100 may include a gripping arm or similar object manipulator that may be arranged to manipulate or otherwise pick up objects from the environment.

The gripper may be under control of the controller 300. Thus, using the on-board imaging means or camera module, the controller 300 may control the flight of the aerial device 100 to position the aerial device 100 relative to the object to allow gripping or handling of the object. For example, using the on-board cameras, the controller 300 may process image data of the surrounding environment to identify an object relative to the aerial device 100. The aerial device 100 may then fly towards the identified object such that the gripper may then be in a position to grasp the object.

As one possibility, the controller 300 may be operable to detect an object such as one object that has been thrown or is falling- and to control the actuators so as to move the second body in order to catch the object therewith. Detection of the object may be performed by the controller by way of processing the image information.

As one possibility, the controller 300 is operable to control the actuators in order to soften a landing on a surface by the second body. When the aerial device 100 has its second body or end effector in contact with a surface—as may occur, for example, following such a landing, the controller 300 may be operable to control the actuators in order to rapidly exert a force on the surface so as cause the aerial device to jump relative to the surface.

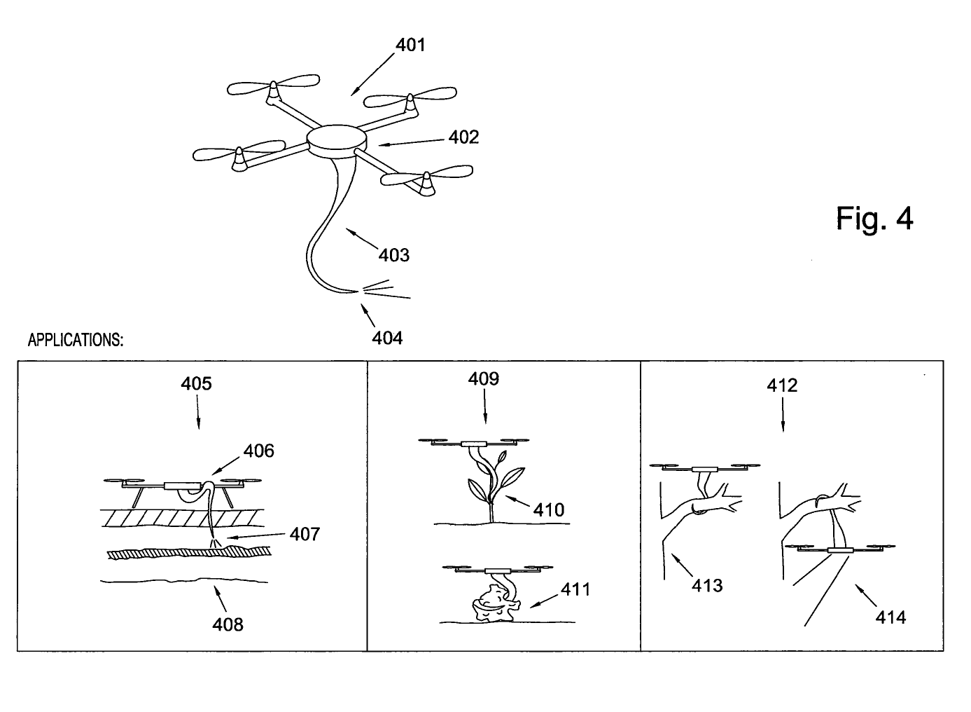

FIG. 4 shows a number of examples of an aerial device capable of controlled flight. In the examples of FIG. 4, the second body is part of a flexible trunk that is flexible relative to the main body of the flying platform of the aerial device and has a nozzle as its substance dispenser at an end thereof. The nozzle may be accompanied by a sharp tip to enable the flexible trunk to perforate substances—such an in order to inject biological material into soil. The flexible trunk may further be operable, in a serpentine manner, to entwine itself around surfaces—such as that of a plant or other material (for example so as to enable the aerial device to pick up material that would be hazardous to a human). Further, the flexible trunk may be arranged to enable the aerial device to hang on to, or perch on, an object and/or to hang therefrom.

In FIG. 4, reference signs 401 to 414 denote:
401: Flying platform, could be extended with legs or wheels to move on ground or walls;
402: Storage of chemicals or biological material (fertilizer, glue, bacteria, fungi);
403: Flexible “trunk” used to spray materials and manipulate objects;
404: Sharp tip and nozzle;
405: Landing on ground and injecting biological material in the soil to manage soil properties;
406: Trunk is penetrating soil; similar to a plant root;
407: Nozzle is spraying organic material or chemicals;
408: Soil;
409: Manipulating objects with flexible trunk that adapts to object geometry;
410: For example, weed;
411: For example, hazardous material;
412: Perching to objects using trunk to attach to structures and observe environment;
413: For example, tree or industrial structure; and
414: Observe/inspect environment.

While the above has been described with respect to an articulated coupling assembly forming part of a delta robot, other articulated coupling assemblies could be used, such as an XYZ stage, an XY gimbal with Z radial depth, a three-axis articulated robotic arm, and/or any of the examples set out in the below table.

| Arm Type | Description | DOF(s) |
|---|---|---|
| Articulated | Robotic arms facilitate movement similar to | 1-7 |
| | Human arms. Actuated joints connect to | |
| | form a kinematic chain. | |
| Gimbal | Pivoted support that allows rotation around | 1-3 |
| | a single axis. Combined to provide support | |
| | for multiple axis. Used in camera rigs for | |
| | stabilisation. | |
| Linear | Linear stages precisely control motion on an | 1-3 |
| | axis. Stages are added to incorporate the | |
| | DOF(s) required with 3D printers typically | |
| | taking this form. | |
| Delta | Parallel type robot where translation is | 3-4 |
| | controlled through triangulation of the head. | |
| | Optional linkage for rotations provide 4 DOF. | |
| | Used in industrial food prorpcsing. | |
| Combination | Application of multiple types. | — |

Furthermore, while in the above a substance dispenser has been used as the end-effector, it will be appreciated by those skilled in the art that the head 208 of the aerial device 100 could instead hold a different end-effector, such as a drill or any other mechanical tool.

There is described herein an aerial device which can be easily controlled and positioned precisely.

There is described herein an aerial device with a head which is lightweight and can thus be moved with low energy and high acceleration, due to the actuators being fixedly coupled to the base (and not the head).

There is described herein an aerial device which is able to maintain a steady absolute position, rather than only a steady look direction.

The approaches described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

As will be appreciated by those skilled in the art, the components of the aerial device can be produced via additive manufacturing, for example via the use of a 3D printer. First, a computer-readable file containing data representative of an aerial device is produced. The data may be representative of the geometry of successive cross-sections of the component. This data is often called ‘slice’ or ‘layer’ data. The data can be produced from a Computer Aided Design (CAD) file, or via the use of a 3D scanner. A 3D printer can then successively lay down layers of material in accordance with the cross-section data to produce the aerial device components.

Further applications of the aerial device described herein include use for repair, inspection, manipulation or chemical treatment of a surface. Also the aerial device could act as a surgical device on animals, plants or people or perform medical assessment or treatment.

There will now be described several further examples relating to aerial devices capable of controlled flight. Features of the examples described below may be readily combined with features described above, as would be understood by the skilled person.

### Overview

This disclosure describes the creation of utilities for the enhancement of micro aerial vehicle, MAV, in the field of aerial construction. Delta arm parallel robot was proposed to provide desired properties for MAV systems. A geometric solution to the delta arm triangulation problem was developed and integrated to the controls system. Creation of a delta arm prototype was made which includes electronic components and control systems that allow for integration onto drone architectures. Finally, the scope of further work to be completed has been outlined for the project.

### 1 Introduction

Aerial robots allow for greater versatility in a wide range of dynamic environments. Construction with the use of aerial robotics is a highly active research area with the promise of developing drones for rapid and advanced construction of complex structures. Micro aerial vehicles, MAVs, use advanced control algorithms to achieve stable flight.

Improving the stability of MAV based actuators would be beneficial for a plethora of MAV based applications. Decoupling an actuator from the MAV to form a two bodied system would allow the actuator to react to errors in the drone's position and provide greater manoeuvrability in the actuator's position.

### 1.1 Aims and Objectives

The aim of this project is to develop a full prototype robotic system to be used on UAVs and the necessary support technologies required for aerial construction. The prototype will be tested in its ability to provide enhancements in manipulating and operating on ground based systems. This would allow for mathematical model to be devised for use on aerial based platforms and act as a proof of concept for future devices.

### 2 Background

Robotics is continuously developing new ways to interact with the environment. A wide variety of robots utilise different arm like configurations to provide the desired degrees of freedom, DOF. The more DOF required the greater complexity introduce and is therefore usually limited to design specific applications. Camera stabilisation is a common problem for MAVs, which is achieved through gimbal mechanisms that control the cameras rotation. Grippers on aerial vehicles are common in commercial application of helicopter deforestation. Actuators on MAVs include grippers mounted directly to the quad copter and full 6 DOF robotic arms have been demonstrated.

Control for MAVs is highly important. Contact or forces imparted to the drone are important to understand for countering their negative effects. Advanced control schemes have been devised for MAV flight that are able to interact with objects.

Recently, construction with MAVs has been implemented and their form and functions have been studied. There are different approaches to the type of structures and the level of prefabrication required. Many structures developed with drones are temporary design implementations for non critical applications. Accuracy of 3D deposition limits the unit size of block material used.

### 3 Theory

In this section, the mathematical models and computer theory are developed for solving the controls of the system and development of electronic systems. Robotic arms require a mathematical solution to relate the position to arm angles. From this a model for control is developed which allows desired positions to be translated to motor rotations. The algorithm was developed to create visualised solutions for both proof of concept and verification. Later models were ported to the control system to allow for calculation on the independent system.

### 3.1 Stability Techniques

Quadcopters suffer from small instabilities and drift in position, similar to all flying vehicles. Maintaining a fixed reference point to the ground is challenging as forces acting in disturbance, such as wind and ground effects, cannot be absorbed through a physical medium and instead must be accounted through thrust vectoring. Quadcopters control is inherently reactive to disturbance, with state estimation only being able to predict a position within an error margin. Latency is also an issue with fixed pitch quadcopters reacting slower, than variable pitch, due to inertia of the blades. Therefore, interaction between bodies must be error tolerant. Creating a stabilising two-body system involves separating the desired degrees of freedom from the drone platform. Gimbals for cameras are currently used to correct for motion in flight and remove vibrations by controlling the rotations. For construction, position is required to be constraint to provide a static reference frame with respect to the world.

To separate the drone and device, a decoupled system was devised. The decoupled system was implemented through a controlled robotic arm for which various types were investigated. Solutions that provide high acceleration with low inertia are desired. Explored systems included an XY Z stage, XY gimbal with Z radial depth(with respect to rotated frame), 3-axis articulated robotic arm and delta arm. Delta arm was chosen for its properties of low inertia linkages, which reduces force imparted to the drone, and high accelerations that can be achieved.

### 3.2 Delta Arm Solver

A delta robot is a type of parallel robot. It houses motors in the base with upper arm linkages restricted to one plane of rotation. Lower arm linkages form a parallel connection that restricts rotations of the head of the robot. Three arms provide control over the desired translation. Motor rotation are measured from the XY plane in-line with the base

Actuators lie in the base of the design and are arrayed around the centre point, z-axis, to provide an equispaced 120°. Three arms are the minimum required to restrict all the axis of motion. Table 3.1 describes the parameters that define the delta arm model.

TABLE 3.1
Delta Arm Parameters

| Parameter | Description |
|---|---|
| lᵤ | Upper arm length (m) |
| lₗ | Lower arm length (m) |
| r_{b} | Radial distance from base centre (m) |
| rₕ | Radial distance from head centre (m) |
| zₙᵢₗ | Head zero position (m) |

Forward solution to the desired position vector x^{T}=[x, y, z] for the joint angles, q_{T}=[θ1, θ₂, θ₃], is solved to provide “end-effector” (head of the delta arm) control. Normalised vectors are define for three points

$${v}_{1} = [ \begin{matrix}1 \\ 0 \\ 0\end{matrix} ] , {v}_{2} = [ \begin{matrix}- 0.5 \\ \frac{\sqrt{3}}{2} \\ 0\end{matrix} ] , {v}_{3 =} [ \begin{matrix}- 0.5 \\ - \frac{\sqrt{3}}{2} \\ 0\end{matrix} ] \qquad ( 3.1 )$$

with vectors being defined in a radial array on the XY plane with v1, v2, and v3 at angles to the X axis of θ=0,120,240 respectively (defined in a counter-clockwise direction). The base and head are offset from the origin to accommodate the motors and device. Head, hₙ, and base, bₙ, nodes are found by

hₙ=rₕvₙ (3.2)

bₙ=r_{b}vₙ+P (3.3)

where P represents the desired position vector with respect to the origin at the base of the quad copter. Planes are defined, by vector notation, for each upper arm which defines the plane the arm lies in.

$${p}_{1} = [ \begin{matrix}0 \\ 1 \\ 0\end{matrix} ] , {p}_{2} = [ \begin{matrix}\frac{\sqrt{3}}{2} \\ 0.5 \\ 0\end{matrix} ] , {p}_{3} = [ \begin{matrix}- \frac{\sqrt{3}}{2} \\ 0.5 \\ 0\end{matrix} ] \qquad ( 3.4 )$$

Solution is calculated through the intersection of a circle and sphere in 3D space. The circle represents the possible locations of the upper arm rotating in 1 DOF, around the base and the sphere, the lower arm rotating around the head in 2 DOF. Three solutions exists that give 0, 2 or infinite number of possible points. No solution is found if the total length is less than the distance of the head to the base, 2 solutions are found for a well formed problem, and infinite if the circle lies on the sphere.

$$f ( n ) = \{ \begin{matrix}0 & if {l}_{u} + {l}_{l} < \vert {h}_{n} - {b}_{n} \vert \\ 2 & if {l}_{u} + {l}_{l} > \vert {h}_{n} - {b}_{n} \vert \\ ∞ & if ( \sqrt{{l}_{l}^{2} - {l}_{u}^{2}} == {h}_{n} - {b}_{n} ) and ( {h}_{n} \times {b}_{n} == 0 )\end{matrix} \qquad ( 3.5 )$$

The vector defining the circle to the sphere

csₙ=hₙ−bₙ. (3.6)

Defining a projection point, sm, that projects the sphere point onto the plane as

smₙ=(pₙ·csₙ)pₙ. (3.7)

The circle to projection point is defined as

cmₙ=csₙ−smₙ. (3.8)

Radius sphere projection, s, is given as

s=\sqrt{lₗ²−|smₙ|²} (3.9)

and defines, by use of Pythagoras theorem, the distance the spheres interaction point makes with the projected point sm. If s=0 both solutions will be identical.

Transformation between the defined plane is given through transformation vectors

$$\begin{matrix}i = \frac{cm}{\vert cm \vert} & ( 3.10 ) \\ j = {p}_{n} \times i & ( 3.11 )\end{matrix}$$

and the points found in space to be

$$\begin{matrix}x = \frac{{\vert cm \vert}^{2} - {s}^{2} + {l}_{u}^{2}}{2 \vert cm \vert} & ( 3.12 ) \\ y = \sqrt{{l}_{u}^{2} - {x}^{2}} . & ( 3.13 )\end{matrix}$$

The two vector positions can then be translated back to Cartesian space with two solutions given as

A=bₙ+ix+jy (3.14)

B=bₙ+ix−jy. (3.15)

In order to select the correct solution, constraints are applied. If A or B contains an imaginary part the solution is non physical, unreachable. If both solutions are real the longest vector formed from the head to origin is the correct point. Pythagoras theorem can then be used to calculate the angle that the upper arm forms with the solved point. Each arm acts independently, and can therefore be updated independently, however the system remains coupled.

### 3.3 Delta Arm Model

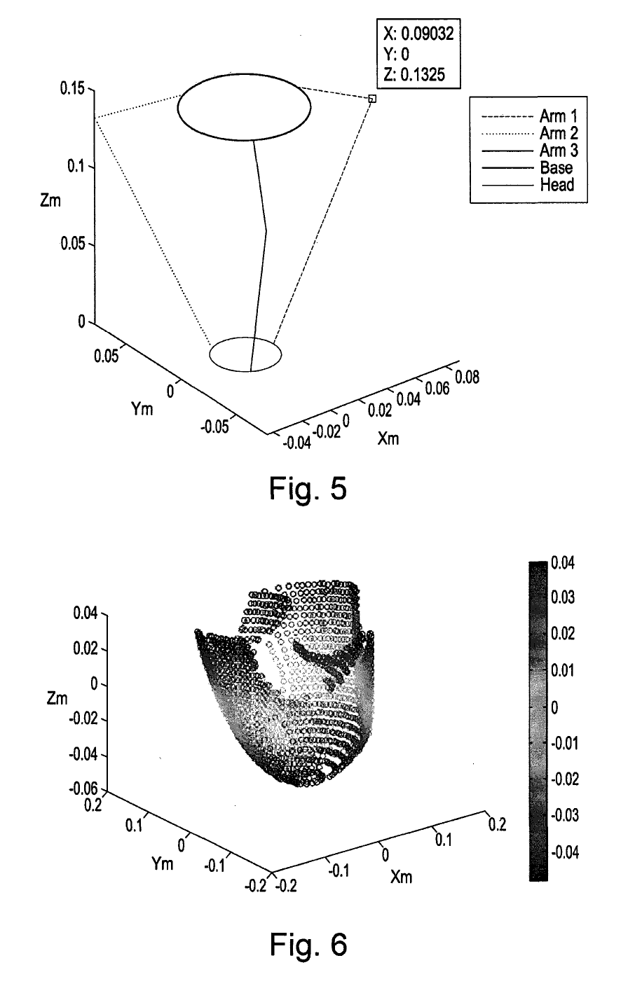

Parameters of the delta arm are required to satisfy the necessary constraints of the drone shown in Table 4.1. Physical limitations in the build area can be visualised from taking into account the delta arm parameters, Table 3.1, which define sizing and the joint limitations for both the upper and lower arms. Rotations for the upper arm were taken between 0°-−90° to allow for quad copter mounting. Lower arm rotations occur on two separate joints, both predicted to act between the range of −45°-+45°. FIG. 5 shows the delta arm parameters with corresponding build area with limitations shown in FIG. 6. Sizing was based on build area simulations and available materials.

Delta arm dynamics are coupled to the motion of the quad copter and positioning of the arms. A simple rigid model was created to solve the initial forces parted to the drone. The lower arm linkages are presumed to act as a single node. A predicted payload of 40 g was prescribed for the payload head. In extreme manoeuvres quad copters can move at 3.5 ms⁻¹ with accelerations of up to 15 ms⁻¹. Under hover conditions acceleration can be assumed to be much lower.

### FIG. 5

Delta arm matlab model showing sizing and positioning of joints for lᵤ=0.06, lₗ=0.15, rₕ=0.04, r_{b}=0.02 and zₙᵢₗ=0.16.

### FIG. 6

Build area map, iterative points scheme for lᵤ=0.06, lₗ=0.15, rₕ=0.04, r_{b}=0.02 and zₙᵢₗ=0.16.

Torques required by the motor can be predicted through solving a simple ridged body model. Lower arms are modelled as a single strut. Internal stresses are ignored. Holding torque can be modelled with the delta arm at 0°, the default position. Torques can then be calculated by

T_{H}=Fd

T_{H}=(Payload(g+a))/3 lᵤ

T_{H}=(0.04(9.81+15))/30.06=0.02 Nm

which can be used to estimate the motors required. As the lower arm angle goes to 0° (with respect to XY plane) the internal stresses in the arms will increase. This is important for validating the build area to ensure the response can be uniform across the device.

### 3.4 Kinematics

Kinematics is a branch of classical mathematics that is used to describe the motion of bodies based on the derivatives, satisfying the second law of motion. Inverse kinematics refer to the use of kinematic equations to describe the relation between the “end-effector” and the system, an analytical solution to the geometric argument presented above. Inverse kinematic play a key part in robotic control theory. Systems are modelled as a set of linked nodes, known as a kinematic chain, each with a parent and a child node. A desired nodal position, usually the end-effector, can be set with solutions obtained for the rotation space.

Kinematic equations can be formed into the Jacobian form by taking the derivatives. The Jacobian form is defined as

$$J = \frac{\partial x}{\partial q} , J = \frac{\partial x}{\partial t} \frac{\partial t}{\partial q} , \dot{x} = J \dot{q} \qquad ( 3.16 )$$

where the velocity vector in Cartesian space, \dot{x}^{T}=[dx, dy, dz,ωₓ,ω_{y},ω_{z}], includes rotations and q defines joint angles. Equation 3.17 defines the mass matrix for each joint, i, with corresponding mass and inertia. Jacobian is formed around the centre of mass of each nodal link.

$${M}_{x} = ( \begin{matrix}{m}_{i} & 0 & 0 & 0 & 0 & 0 \\ 0 & {m}_{i} & 0 & 0 & 0 & 0 \\ 0 & 0 & {m}_{i} & 0 & 0 & 0 \\ 0 & 0 & 0 {I}_{xx} & {I}_{xy} & {I}_{xz} & \\ 0 & 0 & 0 {I}_{yx} & {I}_{yy} & {I}_{yz} & \\ 0 & 0 & 0 {I}_{zx} & {I}_{zy} & {I}_{zz} & \end{matrix} ) \qquad ( 3.17 )$$

Conservation of kinetic energy can be applied to the Jacobian to transfer between Cartesian and joint space.

$$KE = \frac{1}{2} {\sum }_{i = 0}^{n} ( {\dot{x}}_{i}^{T} {M}_{x} {\dot{x}}_{i} ) \qquad ( 3.18 )$$

Substituting 3.16 into 3.18 gives

$$KE = \frac{1}{2} {\dot{q}}^{T} {\sum }_{i = 0}^{n} ( {J}_{i}^{T} {M}_{x} {J}_{i} ) \dot{q} \\ {M}_{q} = {J}^{T} {M}_{x} J \qquad ( 3.19 )$$

Acceleration of the system in joint space:

\ddot{q}=(τ−b(q,\dot{q})−τ_{g})/M_{q} (3.20)

where τ is the torque applied, b is a function defining the Coriolis and centrifugal effects and τ_{g} is the force applied due to gravity.

$${τ}_{g} = {\sum }_{i = 0}^{n} ( {J}_{i}^{T} {F}_{gi} ) \qquad ( 3.21 )$$

### 4 Design and Implementation

This section introduces the design choices and implementation of the robotic arm and construction enabling technologies. Design choices are chosen under constraints of the drone platforms, budget and manufacturing tools.

TABLE 4.1
Drone Constraints

| Drone | Size (mm) | Payload (g) | Accuracy (±cm) |
|---|---|---|---|
| Hummingbird | 540 × 540 × 85.5 | 200 | 2 |
| Pelican | 651 × 651 × 188 | 650 | 2 |

### 4.1 Delta Arm

The delta arm robot is required to be light and fast to facilitate its design goal of being mounted to a drone. Manufacturing of the prototype was done using the available facilities under the Aerial Robotics Lab and Aeronautical Engineering workshop at Imperial College London.

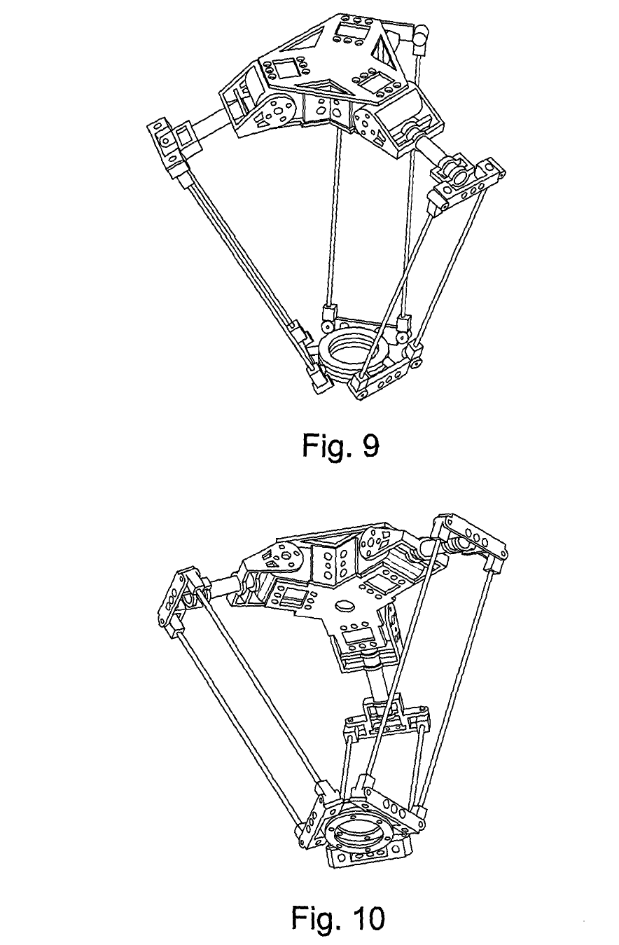

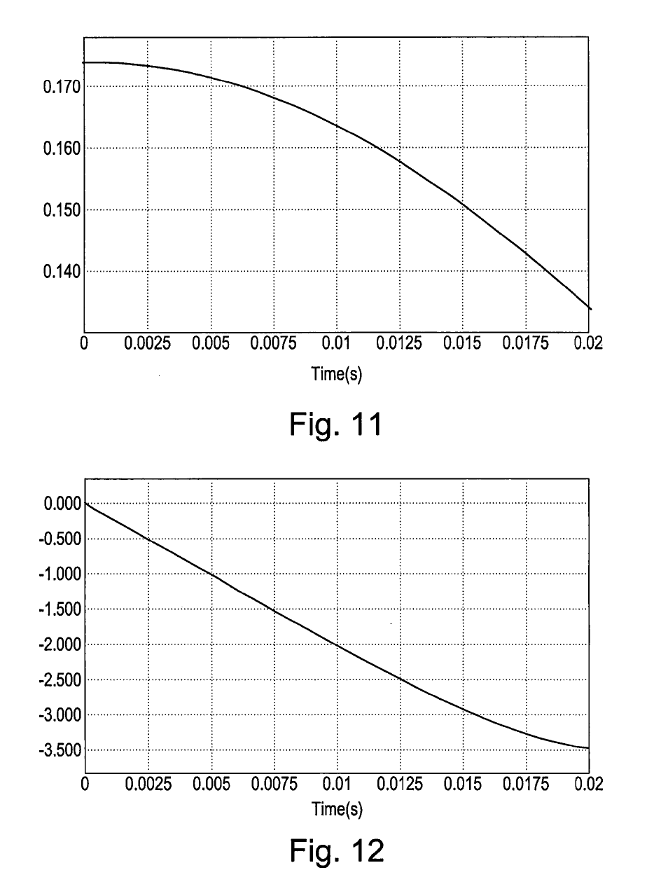

A CAD simulation was developed to enhance development of the robotic arm (shown in FIGS. 9 and 10). Simulations were run to estimate real world performance and predict behaviour (A.3, A.4).

Polyoxymethylene, POM, also known as Acetal and Delrin was the main material used to produce the parts for the Delta Arm. POM is an engineering thermoplastic used in precision parts requiring high stiffness, low friction and excellent dimensional stability. Acrylic was also considered but the higher friction and brittle nature proved less suitable. 3D printing from a Connex system was available but deemed too expensive with material properties inferior to that of POM. Carbon fibre rods were used in manufacturing the linkages and supporting rods for its high stiffness and low weight properties.

Parts were manufactured with a Laser cutter to produce the required accuracy. Accuracy of cutting proved to be around ±0.2 mm either side of the design pattern, measured with micrometer, with variations due to the engravement path. Laser parts were assembled from 2 mm POM with a jigsaw style like configuration to allow for a more rigid assembly. Helper parts were created to position pieces for gluing and enforce structure alignment, which increased accuracy and lowered friction of the final assembly.

Lower arm joints have 2 DOF to create the parallelogram type structure. Commonly found in other and larger delta arm robots are ball joints which provide the required DOF with one joint. We were unable to source appropriate sized rod end joints, and therefore created a 2 joint hinge.

TABLE 4.2
Delta Arm Mass Properties

| Part | Simulated (g) | Prototype (g) |
|---|---|---|
| Head | 5 | 6 |
| Base | 72 | 74 |
| Upper Arm | 5 | 5 |
| Lower Arm | 2 | 3 |
| Total | 109 | 120 |

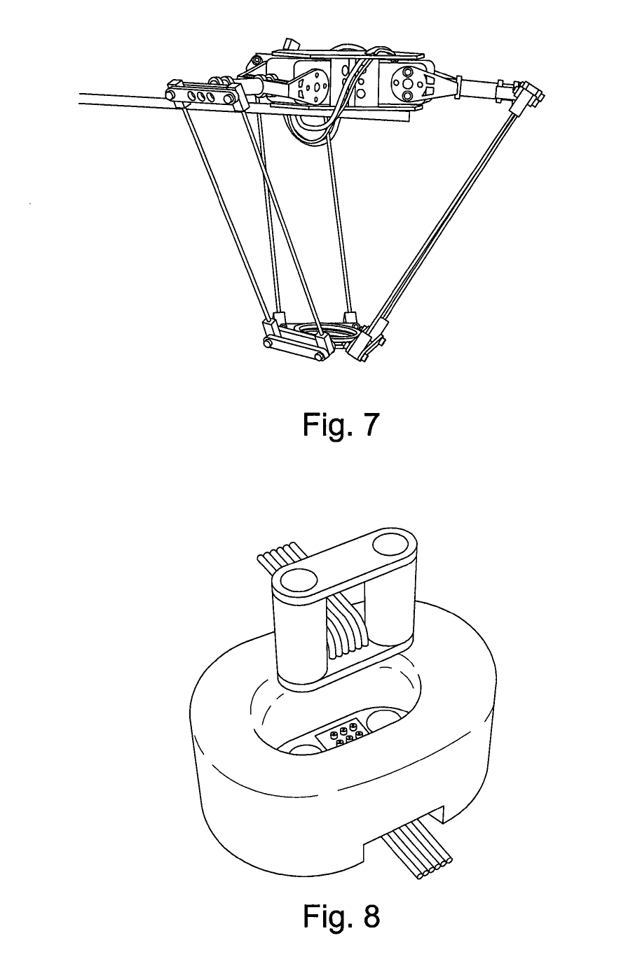

### FIG. 7

Built delta arm prototype shown at θᵢ=0° position.

### 4.2 Controller

Control of the robotic arm needs to receive and command the delta arm with minimal latency. Commands can be received in the form of an offset position compute triangulation of the arm, offloading data processing from computer controller, receive wireless commands from the drone, either through link to drone or wireless link to drone controller. Faster processors will reduce latency as computational time decreases.

The ARM mbed NXP LPC1768 microcontroller is a Cortex-M3 processor in a rapid prototyping form for use in designing different systems. Cortex-M3 has a high clock speed and should prove adequate to controlling the prototype.

Wireless communication is provided by the Xbee WiFi which provides a wireless N network for high data transmission and range. WiFi was chosen over bluetooth and radio to allow for a full digital system with high payloads and ease of connection to controller devices over a wireless network or ad-hoc system.

Communication between devices and controller is formatted into message packets using Google Protobuf. Protocol Buffers is a system developed by Google for communication of serialised data structures that is platform and language neutral. Communication data structures are written once and compiled for different frameworks providing content type protection. This allows communication between a wide variety of devices. Message structure, communicate commands and data positions with error responses.

### 4.3 Motors

Actuator devices for the drones arms are required to be light and powerful enough to provide the necessary power and weight to be utilised on a drone architecture. Motor step and position detection are important to maintain accuracy in movements. It was proven difficult to produce a motor to provide necessary accuracy with weight restrictions for budget stated. We chose the XL-320 above custom encoding devices and brushless motors due to weight, cost and control.

TABLE 4.3
Dynamixel XL-320 Properties

| Weight (g) | Dimensions (mm) | Resolution (o) | Stall Torque (Nm) |
|---|---|---|---|
| 19 | 24 × 36 × 27 | 0.29 | 0.39 |

Largest error in position is given when the upper and lower arm of the delta robot become perpendicular with respect to the plane. Small angle approximation the position error, e, can be evaluated for a rotation error, θₑ, as

$$e = \pm {l}_{u} sin ( {θ}_{e} ) \frac{j - h}{\vert j - h \vert}$$

where j and h represent the joint and head positions. Maximum position displacement is directly related to θₑ as lᵤsin(θₑ).

XL-320 is digitally controlled servo motor. The motor driver (A.1 A.2) was written for the mbed platform following the Dynamixel communication protocol 2.0. The motor features an integrated PID controller which can be set by the controller. This is integrated into the wireless communication to allow the driver to tune the PID in flight which would allow for dynamic operations of payload mass.

### 4.4 Charging

Aerial robotics is largely limited by current generation battery technology. Batteries are relatively heavy with optimal payload versus flight time leaving much to be desired. Manually recharging drones with human interaction is a tedious problem that stops drones from becoming fully autonomous vehicles. A reliable mechanism to connect and recharge the energy stores (or batteries) of drones safely would be a significant step in achieving autonomy.

Lithium-ion polymer batteries, LiPo batteries, is the current technology used in most quad copter drones. Voltage depends on its chemistry and the number of cells used, typically around 3.7V per cell. Batteries are charged with the use of specialised LiPo battery charges that connect with two sets of wires to the battery; discharge leads and balance leads. Balance leads provide connection to each cell. Balancing of the battery cells is required to ensure the battery is charged safely.

From a technology point of view, a simple physical connection system was devised over induction and other more complex solutions, such as laser power transfer, due to constraints in technology maturity and added weight and complexity to the drone. Induction has no physical connection with the charging base which provides a near field of electromagnetic resonance. The charging controller would be required to be built onto the drone, to provide balancing of the battery, which increases weight and complexity. Physical contacts propose a problem due to controller stability especially under ground effect conditions. An error tolerant connection device was required.

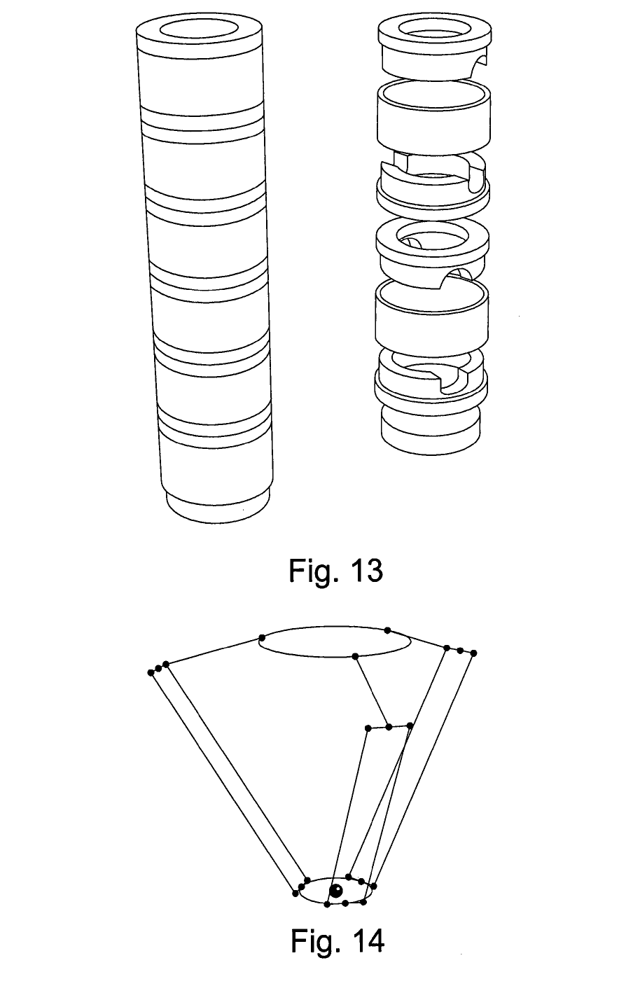

Two concepts were devised for drone mounted charging, shown in FIGS. 8 and 13. Both are similar in operation with different layout of pins in a flat head style configuration, FIG. 8, and a key and barrel lock style, FIG. 13. The physical connection comes from spring loaded contacts, known as pogo pins, that act as conductive spring connectors. The flat head configuration, orientation and position are controlled. Tolerance is provided through a large chamfered edge that resembles the error margin of the drone, acting as a funnel for the charging port. Magnets are placed on either side of the port and base, with opposing polarity to ensure correct orientation and opposing polar orientation on the port to ensure firm connection. Mounting of the port would be on the base or arm linkage of the drone. Vertical configuration, FIG. 13, relinquishes orientation by forming a vertical column of connectors.

Base mechanism proposed is passive and depends on the accuracy of the drone. Base mounting could be spring based to reduce force imparted to the drone on docking. Manufacturing and testing is required to prove validity of devices.

### FIG. 8

Charger prototype features pogo pin and magnetic connectors.

### 5 Further Work

In this section we include some further work and highlight the importance of the ongoing developments with explanations of how they will be accomplished.

### 5.1 Drone Integration

Mounting of the prototype delta arm to the Hummingbird and Pelican will be a significant goal in this project. Controller is tested and all basic functionality for control was achieved. Three main methods of control for the platform are foreseen. Stability: counteracting drone position drift, active: fast actuations superimposed on the drones reference position, and dynamic: dynamic modelling of the system to perform dynamic interactions.

### 5.2 Application Prototypes

Prototype delta arm robot has been developed. Further development would incorporate additional features such as a foam dispensing mechanism that will allow for the creation of 3D structures. A foam-dispensing mechanism has already been developed and it would be used in conjunction to provide a set of useful tools showing the full potential of the device.

Development of other simple prototype applications will be able to showcase the different control types. A simple wireless camera with operator control, gripper and gyro measured payload device, could display the different control types and useful applications for the delta arm.

### 5.3 Dynamic Modelling

A full dynamic model would allow for control state estimation to be integrated into the controller, which potentially allow for greater stability in flight. Further dynamic simulations could be experimented with to provide dynamic operations, for instance the delta arm could be modelled as a spring and damper system between the quadcopter and payload reducing impact forces from rapid manoeuvres.

### 5.4 Charging

Charging requires testing of conceptual ideas to form a reliable docking mechanism. Tolerance and charge rate along with weight are important to document and analyse. PCB has been constructed to form plates for connections along with 3D printed versions of the CAD models. Finally, mounting of charging devices to quad copters for extend anonymous flight would prove a significant goal in this project.

Quadcopter flying platforms suffer from small instabilities and drift in position, similar to all flying vehicles. Maintaining a fixed reference point to the ground is challenging as forces acting in disturbance, such as wind and ground effects, cannot be absorbed through a physical medium and instead must be accounted through thrust vectoring, ie. using flight control to hover precisely in place. However, quadcopters control is inherently reactive to disturbance, and state estimation is only able to predict a position within an error margin. It therefore can only maintain holding position within a certain error margin required to perform construction designs. Using the best platforms available a hover precision of about 7 cm can be reached while hovering close to ground (about 20 cm from ground). This precision is not sufficient for aerial 3d printing, i.e. using a flying vehicle to deposit material precisely in place. Possibilities to stabilise the platforms include (i) Gimbal systems as used for cameras that currently use to correct for motion in flight and remove vibrations by controlling the rotation, (ii) x-y stages that can be attached to the platform, (iii) a delta arm that is integrated on the platform and (iv) a soft trunk that is attached to the platform.

This work outlines the use of such manipulation devices that are integrated on an aerial vehicle with the purpose of using it to precisely deposit material for aerial 3d printing to precisely manipulate objects or use drills and other mechanical tools to fabricate material while the platform is in flight. To achieve the required precision a decoupling of the movement of the aerial platform and the device is required and possibly a separate electronics and sensor pack needs to be integrated to separately stabilise the platform and the manipulator.

Advantages of using an aerial vehicle to manipulate, 3d print and machine objects:
Flexibility: Ability to operate dynamically in space, especially in difficult to access areas such as high altitudes, pipelines, buildings, bridges, roofs etc.
Efficiency and collaborative construction and servicing: Pre-programmed robots that are able to work in cooperation will speed up the construction process.
Precision: Robots can precisely follow trajectories and complicated tasks using visual feedback or external tracking.
Consistency: Provide the ability to carry out construction with the same standard
Safety: Eliminates dangers for human workers, high altitude and dangerous terrain.

A two-bodied system is formed from the decoupling achieved between the quadcopter and device. The devices absolute position is now removed from marginal errors produced from the quadcopter. There are different systems to decouple the device in the form of an XYZ stage, XY gimbal with Z radial depth, 3-axis articulated robotic arms and Delta arm. As a first step we decided to prototype a delta arm, consisting of a parallel robot manipulator with three motors connected to arm linkages. The parallel second arm stage enforces orientation is maintained. Motors are maintained within the base of the robot allowing the arms weight to be minimal, thus greater movement acceleration over a conventional robotic arm. This is important for maintaining a stable reference point and reducing the torque forces passed to the drone. We also developed modelling and control principles that allow the precise control of these arms.

### FIG. 14

Modelling of Delta arm robots.

Stabilisation techniques exist on small quadcopters and other flying vehicles, however there is a fundamental difference in the type of stabilisation achieved. Existing solutions aim to reduce the vibration and planar rotations. This allows devices, such as cameras and other recording equipment, to maintain a steady “look at” position. Absolute position is not controlled. The delta arm robot would provide absolute position stabilisation. This allows devices to act from a defined reference position enabling interaction on other reference points.

An add-on delta arm proof-of-concept prototype is currently under development. A prototype device will be retrofitted to a drone allowing stabilisation in flight. Further development would incorporate additional features such as a foam dispensing mechanism that will allow for the creation of 3D structures. A foam-dispensing mechanism has already been developed and it would be used in conjunction to provide a set of useful tools showing the full potential of the device.

This project aims to create a fully working prototype that will include the following systems: Robotic arm linkages, 3d printing module, motor actuator, control system and a programmable interface providing wireless control.

Commercial applications of robotic stabilisation with flying robots include:
Humanitarian
   Search and rescue, accurate control allows for manoeuvre of objects, provisioning of aid.
   Emergency rescue shelter construction.
Aeronautical Engineering
   Mid flight repairs
Civil Engineering
   Robotic construction
   Building repairs reduce response time allowing for emergency repairs and difficult inaccessible areas compared to conventional ground based techniques.
Military
   Remote autonomous bomb removal/disposal.
   Emergency structure construction.

1. An aerial device capable of controlled flight, the aerial device comprising:
a first body comprising a lift generator for providing lift to the aerial device;
a second body comprising a substance dispenser for controllably dispensing a curable substance for additive manufacture;
an articulated coupling assembly coupling the first body to the second body;
an actuator operable to articulate the articulated coupling assembly so as to move the second body, and thereby the substance dispenser, relative to the first body; and
a controller operable to control: the lift generator, the substance dispenser, and the actuator.

2. The aerial device of claim 1, wherein at least a portion of the actuator is fixedly coupled to the first body.

3. The aerial device of claim 2, wherein the articulated coupling assembly comprises three arms arranged, together with the first body and second body, to form a delta robot.

4. The aerial device of claim 1, wherein the controller is further operable to receive position-related information and to control the actuator based on the received information.

5. The aerial device of claim 4, wherein the position-related information comprises image information from one or more cameras.

6. The aerial device of claim 5, further comprising the one or more cameras.

7. The aerial device of claim 1, further comprising an accelerometer arranged to produce acceleration-related information and provide that information to the controller, and further wherein the controller is operable to control the actuator based on the acceleration-related information.

8. The aerial device of claim 1, wherein the controller is further operable to:
determine a position of the first body or the second body relative to a target, and
based on the determined position, control the actuator in order to move the second body towards the target.

9. The aerial device of claim 8, further comprising an energy store, and wherein the target is a charger operable to provide power to the energy store.

10. The aerial device of claim 1, wherein the controller is further operable to detect an object and to control the actuator in order to catch the object.

11. The aerial device of claim 1, wherein the controller is further operable, when the second body is resting on a surface, to control the actuator in order to jump the aerial device relative to the surface.

12. A method of operating an aerial device, the aerial device comprising a first body comprising a lift generator for providing lift to the aerial device:
a second body comprising a substance dispenser for controllably dispensing a curable substance for additive manufacture;
an articulated coupling assembly coupling the first body to the second body;
an actuator operable to articulate the articulated coupling assembly so as to move the second body, and thereby the substance dispenser, relative to the first body; and
a controller operable to control: the lift generator, the substance dispenser, and the actuator.

13. A computer-readable medium carrying computer-readable instructions arranged, upon execution by a processor, to cause the processor to carry out the method of claim 12.

14. A computer-readable medium having data stored thereon representative of the aerial device according to claim 1, the data being such that it can be relayed to an additive manufacturing device to enable the additive manufacturing device to fabricate the aerial device based on the data.

15. (canceled)
